(19) United States
(12) Patent Application Publication
(10) Pub. No.: US 2015/0071840 A1
(43) Pub. Date: Mar. 12, 2015

(54) CARBON CAPTURE SOLVENTS AND METHODS FOR USING SUCH SOLVENTS

(71) Applicant: Carbon Clean Solutions Pvt. Ltd., Bangalore (IN)

(72) Inventors: Prateek Bumb, Jaipur (Rajasthan) (IN); Prakash D Vaidya, Mumbai (IN)

(73) Assignee: Carbon Clean Solutions Pvt. Ltd., Bangalore (IN)

(21) Appl. No.: 14/388,532

(22) PCT Filed: Mar. 28, 2013
(86) PCT No.: PCT/IB2013/001357

§ 371 Date: Sep. 26, 2014

(30) Foreign Application Priority Data
Mar. 29, 2012 (IN) 923/MUM/2012

(51) Int. Cl. B01D 53/96; B01D 53/62; B01D 53/14

(52) U.S. Cl. CPC B01D 53/96; B01D 53/1493; B01D 53/62
USPC 423/228; 252/190

(57) ABSTRACT

A solvent for recovery of carbon dioxide from gaseous mixture having at least amine, and at least one salt of an amino carboxylic acid or amino sulfonic acids. One specific solvent contains less than about 75% by weight of water and has a single liquid phase.

### PRIORITY

This application claims priority on Indian Application No 923/MUM/2012 filed on Mar. 29, 2012, which is incorporated by reference in its entirety.

### BACKGROUND

This disclosure relates to a method for the preparation of solvents and methods for treatment of industrial effluent gases, and, more specifically, this disclosure relates to solvents and process for using these solvents to aid in the removal of carbon dioxide (CO₂) from other sources such as power plants or industrial utility.

### SUMMARY

This disclosure is directed to a solvent for recovery of carbon dioxide from gaseous mixture having at least amine, and at least one salt of an amino carboxylic acid or amino sulfonic acids. One specific solvent contains less than about 75% by weight of water and has a single liquid phase.

This disclosure also is directed towards a solvent for recovery of carbon dioxide from gaseous mixture having at least one hindered amine and at least one amino acid salt thereof. In specific embodiment, the solvent can have a carbonate buffer. One specific solvent contains less than about 75% by weight of dissolving medium water and has a single liquid phase.

A solvent for recovery of carbon dioxide from gaseous mixture having at least amine, and at least one salt of an amino carboxylic acid or amino sulfonic acids. One specific solvent contains less than about 75% by weight of water and has a single liquid phase.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a schematic picture of the reaction,

FIG. 2 is a perspective view of one illustrative embodiment,

FIG. 3A shows a graph of reaction rate as a function of an exemplary hindered amine concentration at lower concentrations,

FIG. 3B shows a graph of reaction rate as a function of an exemplary hindered amine concentration at higher concentrations,

FIG. 4 shows a graph of the reaction rate as a function of an exemplary amino acid salt at various concentrations of taurate salt,

FIG. 5A shows a graph of the reaction rate as a function of an exemplary hindered amine at 2 M and an exemplary salt at various concentrations,

FIG. 5B shows a graph of the reaction rate as a function of the blend of hindered amine (AMPD), taurine salt comparatively with AMPD and Potassium taurate alone as a function of pressure of CO2,

FIG. 6 shows vapor liquid equilibrium data for AMPD-potassium taurate-CO2-water system.

### DEFINITIONS

As used herein, the term “solvent” can refer to a single solvent or a mixture of solvents.

### DETAILED DESCRIPTION

This disclosure includes several aspects and provides methods and solvents that, when used alone or in combination, may significantly reduce or eliminate carbon dioxide (CO₂) emissions from industrial plants that burn solid fuels, particularly coal-fired power plants. This disclosure is directed to CO₂ capture/sequestration from flue gases CO₂ emissions should also be applicable to CO₂ capture from gas and oil fired boilers, combined cycle power plants, coal gasification, and hydrogen plants, biogas plants.

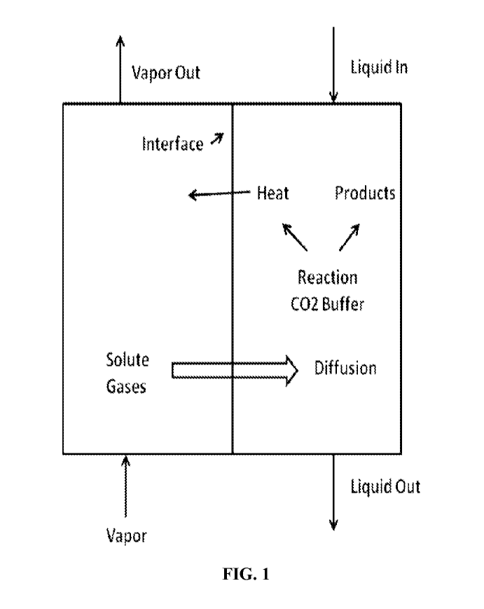

As shown in FIG. 1, the vapor and liquid phases are contact in a small cross-section. In treating the emissions, the absorption step involves removal of acid gases and other components from the gas phase by transport into the liquid phase. The gas-liquid interface separates the phases. An absorbing gas dissolves into the liquid at the interface, then diffuses across a thin layer of liquid (termed the diffusion layer) of one specific solvent. As it diffuses, the gas meets the reactive absorbent component in one specific solvent, reacts with it, and generates heat and reaction products such as carbonate. Reaction products can diffuse into the bulk liquid while the liberated heat of reaction heats the liquid. In one example, there is a mixture of amines, amino acids or salts thereof, a dissolving medium of water as to solvent system remain as a single liquid phase in removing acidic gases from gaseous mixture. In one another example, there is a mixture of tertiary amine/hindered amine, amino acids derivatives, a dissolving medium of water as to solvent system remain as a single liquid phase in removing acidic gases from gaseous mixture.

In one embodiment, the hindered amine compound can be any suitable secondary hindered amine compound (i.e., a hindered amine compound having a hydrogen atom bonded to the nitrogen atom of the amine group). The term “hindered amine” refers to a compound or moiety in which the carbon atoms adjacent to the nitrogen atom of the amine group do not have a hydrogen atom attached directly thereto. The carbon atoms adjacent to the nitrogen atom of the hindered amine compound or moiety may not be carbonyl carbons (i.e., a carbon atom having an oxygen atom double bonded thereto).

One specific solvent may contain hindered or tertiary amines that act as high CO2 loading carrier as the base solvent to increase the capacity of the CO2 capture solvent. Hindered amine/tertiary amine may be N-methyldiethanolamine (MDEA), 2-amino-2-methyl-1-proponal (AMP), 2-(diethylamino)-ethanol (DEAE), diisopropanolamine (DIPA), methylaminopropylamine (MAPA), 3-aminopropanol (AP), 2,2-dimethyl-1,3-propanediamine (DMPDA), 3-amino-1-cyclohexylaminopropane (ACHP), diglycolamine (DGA), 1-amino-2-propanol (MIPA), 2-methyl-methanolamine (MMEA); Di ethyl ethanol amine (DEEA)

In one embodiment, one specific solvent for recovery of carbon dioxide from gaseous mixture includes at least one hindered amine and at least one amino acid, amino acid derivative, amino sulfonic acids or salt thereof. The remaining solvent may be water.

In one embodiment, the solvent contained “amino acids” or salts thereof (e.g., alkali metal salt) that were naturally occurring and non-natural amino acids, as well as amino acid analogs (e.g., taurate) and amino acid mimetics that function in a manner similar to the naturally occurring amino acids. These amino acids may be selected from the 20 common amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine) and pyrolysine and selenocysteine. Amino acid analogs refers to compounds that have the same basic chemical structure as a naturally occurring amino acid, by way of example only, an alpha-carbon that is bound to a hydrogen, a carboxyl group, an amino group, and an R group. Such analogs may have modified R groups (by way of example, norleucine) or may have modified peptide backbones, while still retaining the same basic chemical structure as a naturally occurring amino acid. Non-limiting examples of amino acid analogs include homoserine, norleucine, methionine sulfoxide, methionine methyl sulfonium.

In another embodiment, a taurate is also included in the solvent. Taurine is an amino acid having the chemical formula H₂NCH₂CH₂SO₃H. Taurate is the anionic form of taurine. It is understood that taurine and taurate may exist in equilibrium in solution. Taurates are generally based on taurine, which is also known as 2-aminoethanesulfonic acid. In certain embodiments, suitable taurates may have carbon chains in the range of from C₆ to C₁₈. Examples of suitable taurates include N-alkyl-N-acyl taurate, such as N-methyl-N-palmitoyl taurate, N-methyl-N-cocoyl taurate, N-methyl-N-oleyl taurate, and their lauroyl, myristoyl, and stearoyl homologs. An example taurate comprises N-methyl-N-cocoyl taurate. In some embodiments, the taurate may comprise a metal salt of the N-alkyl taurate. A variety of metal salts of the taurate may be used, including, but not limited to, sodium salts, ammonium salts, potassium salts, calcium salts, and combinations thereof.

In another embodiment, the salt can be of an amino sulfonic acids.

In another embodiment, amino acid, amino derivatives or taurate can be provided in the solvent in the form of a salt, for example, a metal salt, such as the sodium salt. However, the taurate may conceivably be provided in the acid form (taurine). The salts thereof, e.g., potassium and lithium salts and other salts of these compounds, can be prepared without difficulties.

One specific solvent may contain a carbonate salt or buffer. The pH may range for a carbonate buffer may be between 8.0 and 9.0 or between 8 and 11. The amount of carbonate buffer salt used in the buffer system is an amount that is sufficient, when used with the remaining components, to raise salivary pH to a pH of about 7.8 or more, about 8.5 or more, and about 9 or more (e.g., about 9-11), irrespective of the starting pH. For example, carbonate in one specific solvent increases the pH of one specific solvent. This high pH allows for increased carbon dioxide capture in the form of bicarbonate salts. The carbonate can be regenerated when one specific solvent is heated. In some instances percarbonate may contribute to the buffer system.

In another embodiment, the carbonate salt is selected from the group consisting of sodium carbonate, potassium carbonate, calcium carbonate, ammonium carbonate, and magnesium carbonate. In yet another embodiment, the bicarbonate salt is selected from the group consisting of sodium bicarbonate, potassium bicarbonate, calcium bicarbonate, ammonium bicarbonate, and magnesium bicarbonate. In one embodiment, the binary buffer system comprises sodium carbonate and sodium bicarbonate. In another embodiment, the sodium bicarbonate is dessicant-coated sodium bicarbonate.

In another embodiment, the amine-based solvents (such as low CO2 loading capacity, high energy requirement for regeneration, and low resistance to solvent degradation and corrosion) includes AMPD+potassium taurate Salt+H₂O mixtures for enhanced CO₂ capture. AMPD is a sterically hindered amine with high CO₂ loading capacity, whereas taurate salt has high reactivity with CO₂ and improved resistance to oxidative degradation. The proposed mixture provides high CO₂ removal rate, high CO₂ loading capacity, low solvent regeneration cost and increased resistance to degradation.

In an embodiment of the present disclosure, the reactivity of the solvent mixture with CO₂ is higher than that of AMPD+H2O or Taurate+H2O mixtures.

In one example, one specific solvent and method of use for the removal of CO₂ from flue gas, natural gas, hydrogen gas, synthesis gas, and other process and waste gas streams. One specific solvent may contain a carbonate buffer, at least one hindered amine, resulting in the solution pH between (about 10-about 13.5) in absence of CO₂. The amino acids can be 6 wt % to 40 wt % with the total concentration limited by the solid solubility of the amino acids in aqueous solution or of the carbonate buffer salt from 0.15 wt %-10 wt % with total concentration limited by the solid solubility in aqueous solution. This chemical solvent can be designed to increase the rate of CO₂ removal to improve the efficiency of a removal process.

In yet another embodiment, one specific solvent has a hindered amine in a concentration between about 0.5 M to about 4 M. In some examples, the hindered amine can be in a concentration from about 1 M to about 3.5 M. In some examples, the hindered amine can be in a concentration from about 1.5 M to about 3 M. In some examples, the hindered amine can be in a concentration of about 3M In some examples, the salt of amino acid, amino acid derivative or the taurate from about 0.1-3.5 M or from 1 M-2.5 M.

In yet another embodiment, one specific solvent has a solute concentration between about 2 wt %-40 w

In yet another embodiment, one specific solvent has a tertiary balance to keep one specific solvent or solvent system as a single liquid phase. The amount of amino acid can depend in the solutions ability to maintain a single liquid phase.

In another embodiment, a method of removing CO₂ from a gaseous stream including: contacting a gaseous stream with a solution wherein the solution is formed by combining: hindered amines, amino acids salt, and water; whereby the contact removes CO₂ from the gaseous stream; and regenerating the solution. The concentrations may be limited by the solubility of the components at a temperature and contact of the exhaust gaseous stream with one specific solvent removes CO₂ from the gaseous stream; and regenerating the solution.

The regenerating may include heating CO₂-rich solution, which may occur at a temperature of approximately 90 C-130 C, approximately 110 C. An additive such as an antifoaming agent, an antioxidant, a corrosion inhibitor (e.g. vanadium oxide or a chromate), a flocculation aid, or a mixture of two or more additives may be included as part of the solution.

In another embodiment, the method of removing CO₂ from a gaseous stream may further include applying a water wash system, wherein the water wash system collects the volatile hindered amines and amino acids from treated gaseous stream. The regeneration of the solution may occur in a vacuum stripper column, and the solution may be returned to contact with the gaseous stream after regeneration.

Other components of a gaseous stream, such as COS may also be removed by the method of this disclosure. The gaseous stream may be from a coal-fired power plant, or it may be flue gas, natural gas, hydrogen gas, synthesis gas or a waste gas stream.

FIG. 2 is a schematic diagram of an apparatus for removing acidic gases especially CO₂. As shown in FIG. 2, gas is allowed to enter to an absorption tower 1 through a CO₂-containing gas-feed. In a packed portion, the gas placed in the absorption tower 1 is brought into contact in a counter flow with a CO₂ absorbent liquid fed from 3, and CO₂ is absorb and removed from the gas by the absorbing liquid, and the resultant gas is discharge from the top as treated gas. The absorbent liquid fed to the absorption tower 1 absorb CO₂, and is led to heat exchanger and heated and led to a regeneration tower 4. In the regeneration tower 4, the absorbent liquid flows through a packed portion towards the lower portion of the tower. During this time, CO₂ is removed to regenerate the absorbent liquid. The regenerated absorbent liquid is led by a pump to the heat exchanger and fed back to the absorption tower 1 through an absorbent liquid feed inlet line 3.

On the other hand, in the upper portion of the regeneration tower 4, the CO₂ removed from the absorbent liquid is brought into contact with a reflux water, and cooled by a regeneration tower reflux condenser and, in a reflux drum, the CO₂ separated from the reflux water formed by condensing water vapor accompanying the CO₂, and led to a CO₂ recovery step. The reflux water is fed by a reflux water pump to the regenerator tower 4. This embodiment briefly describes an overview of the CO₂ capture process description.

### EXAMPLES

The disclosure will be further described in connection with the following examples, which are set forth for purposes of illustration only.

### Example A

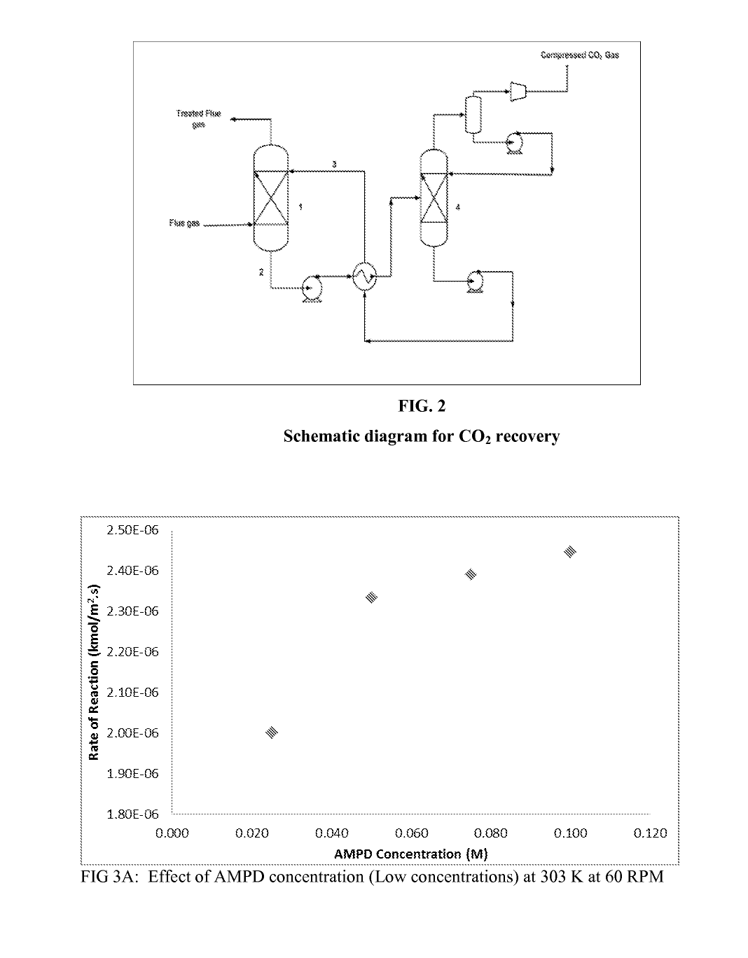

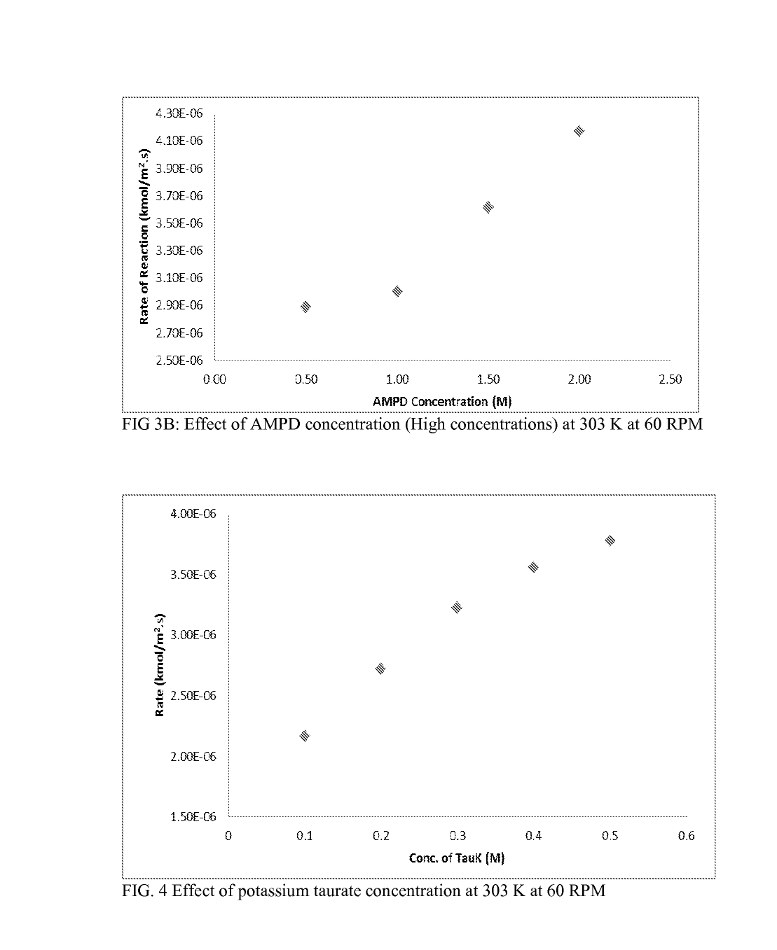

For an exemplary AMPD-CO₂ system, the effect of concentration at low AMPD concentrations and at high AMPD concentrations is shown in FIG. 3A and FIG. 3B, respectively. Table 1 and Table 2 provide the data showing these effects. The effect of CO₂ pressure at low AMPD concentrations as well as at high AMPD concentrations was studied. The rate increases with a rise in amine concentration.

TABLE 1
Effect of AMPD concentration (Low concentrations) at 303 K at 60 RPM

| Pressure | AMPD Concentration | Rate of reaction |
|---|---|---|
| kPa | M | kmol/m² · s |
| 6.42 | 0.025 | 2.00E−06 |
| 6.11 | 0.050 | 2.33E−06 |
| 4.17 | 0.075 | 2.39E−06 |
| 6.61 | 0.100 | 2.45E−06 |

TABLE 2
Effect of AMPD concentration (High concentrations) at 303 K at 60 RPM

| Pressure | AMPD Concentration | Rate of reaction |
|---|---|---|
| kPa | M | kmol/m² · s |
| 3.89 | 0.50 | 2.89E−06 |
| 3.74 | 1.00 | 3.00E−06 |
| 4.13 | 1.50 | 3.61E−06 |
| 4.8 | 2.00 | 4.17E−06 |

### Potassium Taurate-CO₂ System

For an exemplary taurate-CO₂ system, the effect of concentration at various taurate concentrations is shown in FIG. 4, and Table 3 provides the data showing these effects.

TABLE 3
Effect of potassium taurate concentration at 303 K at 60 RPM.

| Pressure | TauK concentration | Rate |
|---|---|---|
| kPa | M | kmol/m² · s |
| 4.48 | 0.1 | 2.17E−06 |
| 3.71 | 0.2 | 2.72E−06 |
| 4.02 | 0.3 | 3.22E−06 |
| 5.29 | 0.4 | 3.56E−06 |
| 5.32 | 0.5 | 3.78E−06 |

### AMPD-Potassium Taurate-CO₂ System

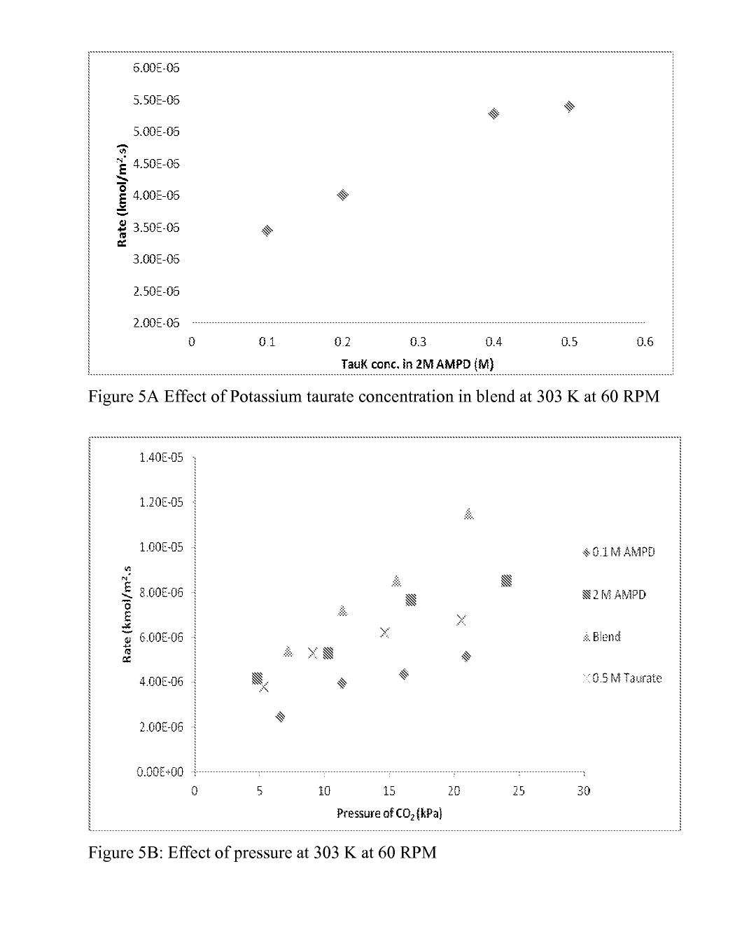

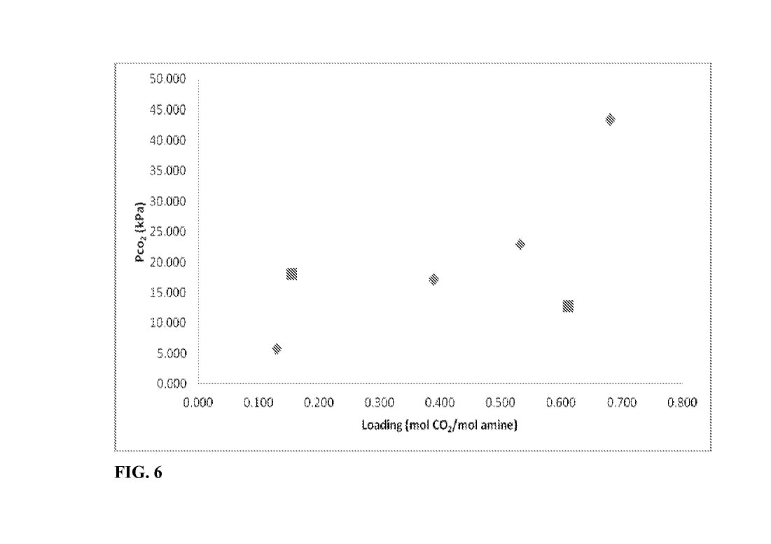

The effect of potassium taurate concentration on CO₂ absorption rate was shown in Table 4 and FIG. 5A. Blend solutions having AMPD concentration of 2 M and potassium taurate concentration ranging from 0.1M to 0.5 M were examined to calculate the rate of absorption. Potassium taurate is an effective activator in aqueous AMPD solutions.

TABLE 4
Effect of Potassium taurate concentration in blend at 303 K at 60 RPM

| Pressure | AMPD Concentration | Taurate concentration | Rate |
|---|---|---|---|
| kPa | M | M | kmol/m² · s |
| 3.87 | 2 | 0.1 | 3.45E−06 |
| 4.91 | 2 | 0.2 | 4.00E−06 |
| 5.33 | 2 | 0.4 | 5.28E−06 |
| 7.18 | 2 | 0.5 | 5.39E−06 |

Effect of pressure for 0.1 M AMPD, 2 M AMPD, 0.5 M potassium taurate and blend of 2 M AMPD with 0.5 potassium taurate is shown in Table 5 and FIG. 5B.

TABLE 5
Effect of pressure at 303 K at 60 RPM

| | | | | | | 0.5M potassium | |
|---|---|---|---|---|---|---|---|
| 0.1M AMPD | | 2M AMPD | | 2M AMPD + 0.5 | | taurate | |
| Presssure | Rate | Presssure | Rate | Presssure | Rate | Presssure | Rate |
| kPa | kmol/m² · s | kPa | kmol/m² · s | kPa | kmol/m² · s | kPa | kmol/m² · s |
| 6.61 | 2.45E−06 | 4.80 | 4.17E−06 | 7.18 | 5.39E−06 | 5.32 | 3.78E−06 |
| 11.33 | 3.95E−06 | 10.24 | 5.28E−06 | 11.39 | 7.22E−06 | 9.10 | 5.28E−06 |
| 16.13 | 4.33E−06 | 16.68 | 7.67E−06 | 15.55 | 8.56E−06 | 14.63 | 6.22E−06 |
| 20.92 | 5.11E−06 | 24.01 | 8.50E−06 | 21.08 | 1.15E−05 | 20.55 | 6.78E−06 |

### AMPD-Potassium Taurate-CO₂-Water System

Blend solution containing 2 M AMPD and 0.5 M potassium taurate was prepared and used to generate the VLE data and is shown in Table 6 and FIG. 6.

NTABLE 6
VLE data for AMPD-potassium taurate-CO₂-water system

| | |
|---|---|
| Loading, α | Pco₂ |

| No. | mol/mol | atm | kPa |
|---|---|---|---|
| 1 | 0.130 | 0.057 | 5.772 |
| 2 | 0.155 | 0.178 | 18.031 |
| 3 | 0.389 | 0.169 | 17.115 |
| 4 | 0.533 | 0.227 | 22.963 |
| 5 | 0.681 | 0.428 | 43.414 |
| 6 | 0.612 | 0.126 | 12.756 |

### Example B

Data from blend solution containing 30 wt % AMP and 15 wt % Potassium Dimethyl Glycinate and remaining water is shown in Table 7 and FIG. 6.

TABLE 7

| Sr, No | Loading (mol/mol) | PCO2 (kPa) |
|---|---|---|
| 1 | 0.93 | 9.11 |
| 2 | 0.74 | 7.43 |
| 3 | 0.56 | 6.38 |
| 4 | 0.37 | 5.92 |
| 5 | 0.18 | 5.87 |
| 6 | 0.09 | 5.92 |
| 7. | 0.04 | 5.95 |

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A solvent for recovery of carbon dioxide from gaseous mixture, comprising:
(a) At least amine, and
(b) At least one salt of an amino carboxylic acid or amino sulfonic acids, wherein one specific solvent contains less than about 75% by weight of water and has a single liquid phase.

2. The solvent as claimed in claim 1, wherein the amine is selected from hindered amines.

3. The solvent as claimed in claim 1, wherein the amino sulfonic acid is a taurine and the salt is a taurate.

4. The solvent as claimed in claim 1, wherein the amine is an amine of the formula (I), (II) where x and y respectively satisfy relationship: 1 less than or equal to 5 and 2 less than or equal to 10; and R¹, R², R³, and R⁴ represent —CᵢHⱼOₖNₗ (where i=0 to 10, j=1 to 21, k=0 to 5, and l=0 to 5).

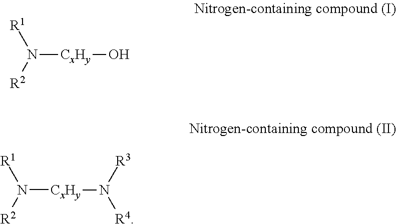

5. The solvent as claimed in claim 1, wherein the amine is selected from cyclic amine which are either secondary amine or tertiary amines.

6.

7. The solvent as claimed in claim 1, wherein the amine is selected from the group consisting of monoethanolamine (MEA), methyldiethanolamine (MDEA), diethanolamine (DEA), triethanolamine (TEA), diisopropanolamine (DIPA), 2-amino-1-propanol (AP), 2-amino-2-methylpropanol (AMP), ethyldiethanolamine (EDEA), 2-methylaminoethanol, 2-ethylaminoethanol (EAE), 2-n-propylaminoethanol, 2-nbutylaminoethanol (n-BAE), 2-n pentylaminoethanol, 2-isobutylaminoethanol (IBAE), 2-dimethylaminoethanol (DMAE) and 2-diethylaminoethanol (DEAE), N,N-diethylethanolamine, 2-amino-2-methyl-1,3-propanediol (AMPD), 2-amino-2-methyl-1,3-propanediol (AHPD), 2-amino-2-ethyl-1,3-propanediol (AEPD), and combination thereof.

8. The solvent as claimed in claim 1, wherein the amine is selected from the group consisting of 2-amino-2-methyl-1,3-propanediol (AMPD), methyldiethanolamine (MDEA), 2-amino-2-methylpropanol (AMP) and combinations thereof.

9. The solvent as claimed in claim 1, wherein the amine is 2-amino-2-methyl-1,3-propanediol (AMPD) and the molar concentration of AMPD is between about 0.5 M to about 4 M.

10. The solvent as claimed in claim 1, wherein the salt is potassium salt.

11. The solvent as claimed in claim 1, wherein the salt of amino carboxylic acid or sulfonic acid selected from the group consisting of: potassium taurate, potassium glycinate, potassium alkalinate, potassium prolinate, potassium N—N dimethyl glycinate, potassium 3-dimethyl aminoproponate, potassium dimethyl aminoisobutyrate potassium aminoisobutyrate, potassium methylamino isobutyrate potassium taurate, and combination thereof.

12. The solvent as claimed in claim 11, wherein total molar concentration of potassium taurate is 0.1M to 3.5 M.

13. A method for removing CO₂ from a stream, comprising the steps of:
(a) contacting the stream with a solvent having an Amine, salt of amino carboxylic acid or salt of amino sulfonic acid;
(b) allowing one specific solvent to absorb CO₂ at a temperature;
(c) regenerating one specific solvent from heating one specific solvent greater than 80.

14. The method as claimed in claim 13, wherein the stream has a temperature between 40 C to 65 C.

15. The method as claimed in claim 13, wherein the amine is amino-2-methyl-1,3-propanediol (AMPD) and the salt of the amino sulfonic acid is taurate.
